(19) United States
(12) Patent Application Publication
(10) Pub. No.: US 2022/0215530 A1
(43) Pub. Date: Jul. 7, 2022

(54) An Apparatus and Method for Imaging Containers

(71) Applicant: OCADO INNOVATION LIMITED, Hatfield, Hertfordshire (GB)

(72) Inventors: Tom CLANCY, Hatfield, Hertfordshire (GB); Ivaylo POPOV, Hatfield, Hertfordshire (GB); Christos MAKRIS, Hatfield, Hertfordshire (GB)

(73) Assignee: OCADO INNOVATION LIMITED, Hatfield, Hertfordshire (GB)

(21) Appl. No.: 17/594,882

(22) PCT Filed: Apr. 28, 2020
(86) PCT No.: PCT/EP2020/061798

§ 371 Date: Nov. 2, 2021

(30) Foreign Application Priority Data
May 2, 2019 (GB) 1906157.1

(51) Int. Cl. G06T 7/00; G06T 7/70; G06V 10/778; G06V 20/52; B65G 1/137; B65G 43/08

(52) U.S. Cl. CPC G06T 7/0008; G06T 7/70; G06V 10/7796; B65G 2201/0235; B65G 1/1371; B65G 43/08; G06V 20/52

(57) ABSTRACT

A control unit is disclosed to control an imaging unit to perform imaging of a tray/container. The control unit can cause the performance of actions on the container using automated machines and/or directing humans to perform an action. For example, the presence of contamination in a container can be detected based on an image of the container captured by an imaging unit. The control unit can receive an image of the container from the imaging unit, determine whether the container is contaminated, and direct the container to a cleaning unit. Moreover, the control unit can detect a product based on an image of the product, determine an identity of the product based on the received image, and command an indicating unit to indicate a failure to determine the identity of the product.

This application claims priority from UK Patent Application No. GB1906157.1 filed 2 May 2019, the content of all this application hereby being incorporated by reference.

### TECHNICAL FIELD

The present invention relates generally to the field of imaging and more specifically to an apparatus and method for imaging a container.

### BACKGROUND

In warehouses goods/products/items are often stored and moved on trays or in containers. Traditionally, all operations to do with trays/containers are performed manually or with the assistance of manually operated machines. For example, containers are loaded by humans and moved around warehouses using fork lift trucks and the like.

In more modern warehouses, automated transportation means have been utilised to move trays/containers from one location in a warehouse to another location in the warehouse. For example, the use of conveyor belts may be used to automatically move trays/containers across a warehouse.

However, operations on containers are still performed manually which can be slow and requires large amounts of human labour. There is therefore a need to at least partially automate tray/container operations.

### SUMMARY

In view of the problems in known tray/container operations, the present invention aims to provide an apparatus and method for such partial/full automation of container/tray operations.

In general terms, the invention introduces the use of a control unit to control an imaging unit to perform imaging of a tray/container. The control unit is further arranged to cause the performance of actions on the container using automated machines and/or directing humans to perform an action.

According to the present invention there is provided a control unit arranged to detect the presence of contamination in a container based on an image of the container captured by an imaging unit, the control unit comprising a receiving unit arranged to receive an image of the container from the imaging unit. The control unit further comprises a determining unit arranged to determine whether the container is contaminated based on the received image and a commanding unit arranged to, when the determining unit determines that the container is contaminated, direct the container to a cleaning unit.

The present invention also provides a control unit arranged to detect a product based on an image of the product captured by an imaging unit, the control unit comprising an image receiving unit arranged to receive an image of the product from the imaging unit. The control unit further comprises a determining unit arranged to determine an identity of the product based on the received image and a commanding unit arranged to, when the determining unit fails to determine the identity of the product, command an indicating unit to indicate that the determining unit has failed to determine the identity of the product.

The present invention also provides a storage system comprising a first set of parallel rails or tracks extending in an X-direction, and a second set of parallel rails or tracks extending in a Y-direction transverse to the first set in a substantially horizontal plane to form a grid pattern comprising a plurality of grid spaces and a plurality of stacks of containers located beneath the rails, and arranged such that each stack is located within a footprint of a single grid space and a transporting device, the transporting device being arranged to selectively move in the X and/or Y directions, above the stacks on the rails and arranged to transport a container. The present invention further comprises a cleaning unit and a control unit as previously described, wherein the control unit is arranged to image a container received from the transporting device.

The present invention also provides a storage system comprising a first set of parallel rails or tracks extending in an X-direction, and a second set of parallel rails or tracks extending in a Y-direction transverse to the first set in a substantially horizontal plane to form a grid pattern comprising a plurality of grid spaces, a plurality of stacks of containers located beneath the rails, and arranged such that each stack is located within a footprint of a single grid space and a transporting device, the transporting device being arranged to selectively move in the X and/or Y directions, above the stacks on the rails and arranged to transport a container. The present invention further comprises a picking station arranged to receive a product stored in a container transported by the transporting device and a control unit as previously described.

The present invention also provides a method of detecting the presence of contamination in a container based on an image of the container captured by an imaging unit, the method comprising the steps of receiving an image of the container from the imaging unit, determining whether the container is contaminated based on the received image and directing the container to a cleaning unit when the determining step determines that the container is contaminated.

The present invention also provides a method of detecting a product based on an image of the product captured by an imaging unit, the method comprising receiving an image of the product from the imaging unit, determining an identity of the product based on the received image and commanding, when the determining step fails to determine the identity of the product, an indicating unit to indicate that the determining step has failed to determine the identity of the product.

The present invention also provides a storage system comprising a first set of parallel rails or tracks extending in an X-direction, and a second set of parallel rails or tracks extending in a Y-direction transverse to the first set in a substantially horizontal plane to form a grid pattern comprising a plurality of grid spaces, a plurality of stacks of containers located beneath the rails, and arranged such that each stack is located within a footprint of a single grid space and a transporting device, the transporting device being arranged to selectively move in the X and/or Y directions, above the stacks on the rails and arranged to transport a container. The present invention further comprises a cleaning unit.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a diagram of a control unit according to a first embodiment of the present invention together with associated peripherals to detect contaminated containers.

FIG. 2 is a schematic diagram of a control unit according to a first embodiment of the present invention.

FIG. 3 is a flowchart of the processes performed by the control unit according to a first embodiment of the present invention.

FIG. 4 is a diagram of a control unit according to a second embodiment of the present invention together with associated peripherals to assist in the picking of products from a container.

FIG. 5 is a schematic diagram of a control unit according to a second embodiment of the present invention.

FIG. 6 is a flowchart of the processes performed by the control unit according to a second embodiment of the present invention.

FIG. 7 is a schematic diagram of a framework structure according to a known system.

FIG. 8 is a schematic diagram of a top-down view showing a stack of bins arranged within the framework structure of FIG. 7.

FIGS. 9(a) and 9(b) are schematic perspective views of a load handling device depositing a bin and FIG. 9(c) is a schematic front perspective view of a load handling device lifting a bin.

FIG. 10 is a schematic diagram of a system showing load handling devices operating on the framework structure.

### DETAILED DESCRIPTION OF EMBODIMENTS

### First Embodiment

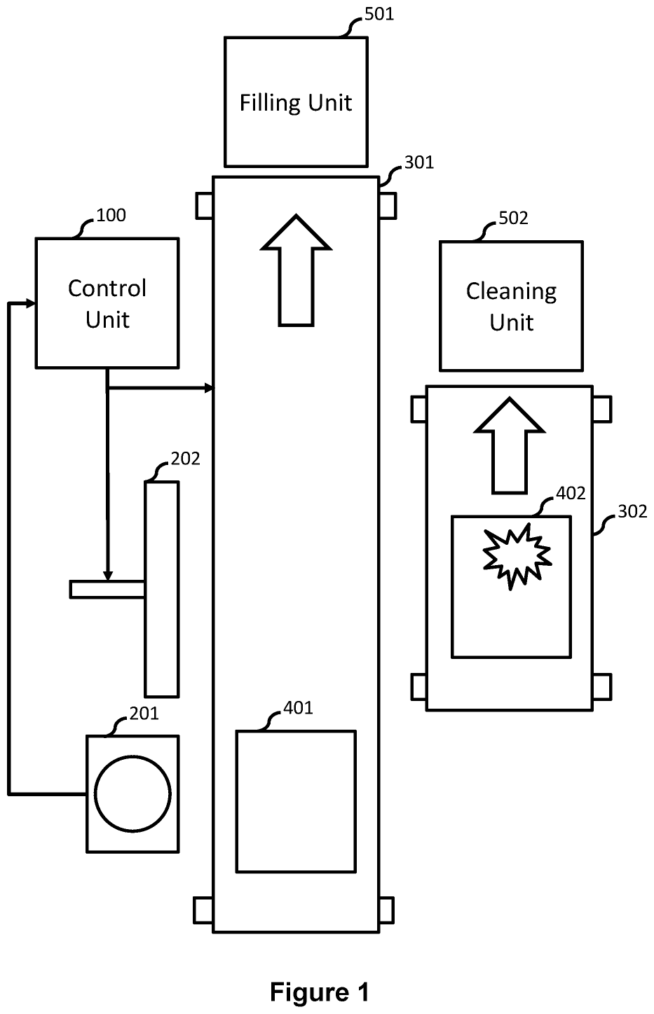

FIG. 1 depicts a control unit 100 according to the first embodiment of the present invention together with further peripherals which may be used in conjunction with the control unit 100.

In particular, the control unit 100 may be used in conjunction with an imaging unit 201 (e.g. a camera) and a diverting unit 202. The imaging unit 201 is arranged to image a container 401.

In this description, with regard to all embodiments described herein, the term “container” is envisaged any means for storing products to be moved around a warehouse. Therefore, it is envisaged to encompass terms such as tote, tray and pallet. In particular, each of these storing means is arranged to contain thereon/therein products to be moved around a warehouse.

In this example, the container 401 is arranged to travel on a first conveying means 301 (such as a conveyor belt, autonomous vehicles for carrying containers 401 and the like) towards a filling unit 501. In this example, the filling unit 501 might be a location at which products are to be placed in the container 401. Therefore, the container 401 may be imaged whilst it is empty, for example, having been emptied at a destination before returning to the warehouse to be refilled at the filling unit 501 ready to be dispatched to another destination. However, as a result of the products it contained and/or the environments in which it has moved the container 401 may have become contaminated. For example, a liquid may have spilled on the bottom of the container 401 and/or a sticky substance may have adhered itself to the container 401. Therefore, the container 401 is unsuitable for filling at the filling unit 501 because doing so would contaminate then products being placed into the container 401 at the filling unit 501.

Therefore, FIG. 1 further shows a second conveying means 302 arranged to convey containers to a cleaning unit 502. In this example, a container 402 is shown being conveyed by the second conveying means 302 towards the cleaning unit 502. In particular, the container 402 is contaminated and therefore needs cleaning before being available for filling in a filling unit 501. To this end, the cleaning unit 502 is envisaged to be manually or automatically operated with an operative performing the cleaning of the container 402 and/or with a machine arranged to perform the cleaning operation.

After cleaning, the container 402 may be directed to a filling unit 501 to be filled with products for transport to a destination.

Traditionally, operatives are required to notice contamination of containers 401 prior to filling and then to manually direct the container 401 to a cleaning unit 502 before filling them. However, this is labour intensive and disruptive to the work of operatives at the filling unit 501.

Therefore, the control unit 100 is arranged to automatically detect contamination in the container 401 and direct the container to the cleaning unit 502 when required or permit the container 401 to continue to the filling unit 501. Therefore, the imaging unit 201 is arranged to image the container 401. The image of the container 401 is received by the control unit 100 which is arranged to determine whether the container 401 is contaminated. If the control unit 100 determines that the container 401 is not contaminated then the control unit 100 may be arranged to direct the container 401 to the filling unit 501 to be filled with products. However, if the container 401 is determined to be contaminated then the control unit 100 is arranged to direct the container 401 to the cleaning unit 502 to be cleaned.

To achieve this, the control unit 100 may be arranged to control the first conveying means 301 and/or the diverting unit 202 to direct the container 401 as appropriate. For example, if the container 401 is determined to be uncontaminated then the control unit 100 may activate the first conveying means 301 to convey the container 401 directly to the filling unit 501. However, if the container 401 is determined to be contaminated then the control unit 100 may be arranged to activate the diverting unit 202 which, in this example, is envisaged to be a pushing plate arranged to push a container 401 sideways onto the second conveying means 302. However, other means of diverting a container 401 are envisaged such as using tracks which may be switched to change the direction of a container 401 and/or conveying means 301 such as the Intralox Activated Roller Belt which is able to move containers 401 in two perpendicular directions. Moreover, instead of pushing the contaminated container onto a second conveying means 302 it is envisaged that the container 401 may be pushed directly to the cleaning unit 502 thereby eliminating the need for the second conveying means 302.

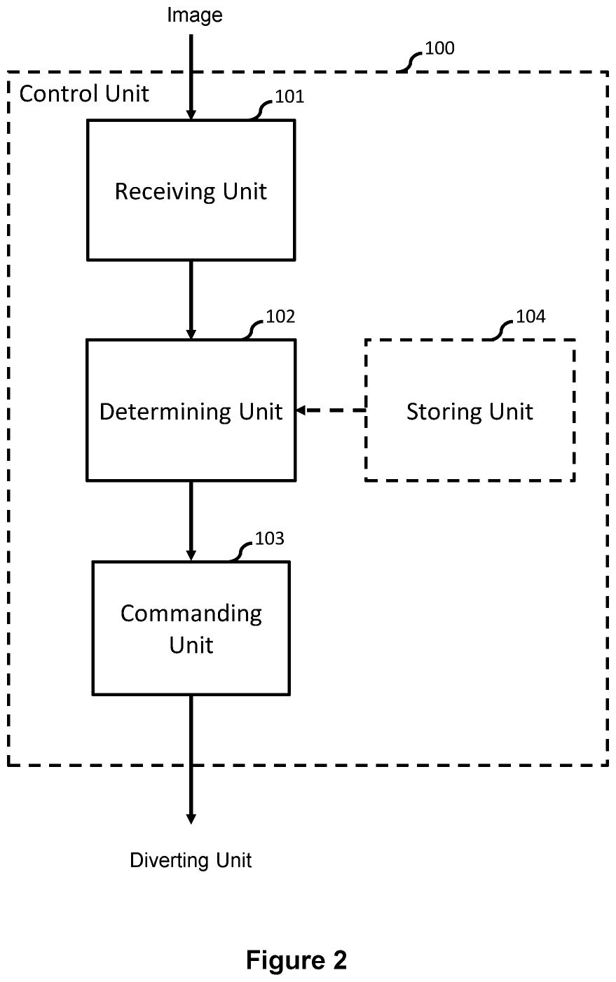

FIG. 2 is a schematic diagram of the control unit 100 according to the first embodiment. The control unit 100 comprises a receiving unit 101, a determining unit 102 and a commanding unit 103. Optionally, the control 100 may further comprise a storing unit 104.

The receiving unit 101 is arranged to receive the image of the container 401 from the imaging unit 201. Optionally, the receiving unit 101 may be arranged to process the image such as cropping the image, rotating the image, adjusting the colouring etc. so that images used by the determining unit 102 are consistent and as similar as possible.

The determining unit 102 is arranged to receive the image from the receiving unit 101 and arranged to determine whether the container is contaminated based on the received image. In particular, the determining unit 102 may be arranged to use a statistical model and/or a machine-learning model to determine whether the container in the received image is contaminated. Moreover, the determining unit 102 may be arranged to determine whether the container 102 is blurry, unclear, not a container etc. in other words, to determine exceptions as to whether the container is contaminated. In the case of an exception, the determining unit 102 may alert a human operator to the problem and accept an override command. Alternatively, the determining unit 102 may be arranged to command the imaging unit 201 to capture a further image of the container from which a definite determination may be made as to whether the container is contaminated or not.

Optionally, the determining unit 102 may determine a percentage confidence in the determination that a container 401 is contaminated. For example, a 70% confidence that the imaged container 401 is contaminated or a 20% confidence that the imaged container 401 is contaminated. The determined percentage confidence may be thresholded, for example, at 40%. Therefore, for containers with a percentage confidence of contamination equal to or above 40% the control unit 100 may direct them to the cleaning unit 501. On the other hand, for containers with a percentage confidence below 40% the control unit 100 may direct them to the filling unit 501.

To achieve this, the control unit 100 further comprises a commanding unit 103. The commanding unit 103 is arranged to, when the determining unit determines that the container 401 is contaminated, direct the container 401 to the cleaning unit 502. Conversely, the commanding unit 103 may be arranged to, when the determining unit determines that the container 401 is not contaminated, direct the container 401 to the filling unit 501. To achieve this, the commanding unit 103 may be arranged to control the first conveying means 301 and/or the diverting unit 202 so as to selectively determine whether a container 401 travels to the filling unit 501 or the cleaning unit 502. As described previously, the diverting unit 202 is envisaged to be a number of different technologies, each which may require specialised control. To this end, the control unit 100 may control the diverting unit 202 in conjunction with the first conveying means 301 to direct the container 401 in the direction required.

Optionally, the control unit 100 may further comprise a storing unit 104. The storing unit 104 may be arranged to store information which may be used to train the machine-learning model/statistical model used by the determining unit 102. In particular, the storing unit may be arranged to store images captured by the imaging unit of containers which are contaminated and which have been identified as such (such as by a human operative). Similarly, the storing unit may further store images captured by the imaging unit of containers which are not contaminated and which have been identified as such (such as by a human operative). In this way, the information stored in the storing unit 104 may be used to train the determining unit 102 to determine whether a container is contaminated or uncontaminated.

It is envisaged that the determining unit 102 may be trained once and offline, in other words, the machine-learning model need only be trained a single time using the information stored in the storing unit 104 after which the determining unit 102 may be able to suitably determine whether a container is contaminated or not. Moreover, such training need not occur whilst the control unit 100 is operating but rather prior to it being put into use so that when first used the determining unit 102 is suitably trained so as to determine whether a container is contaminated or not.

Optionally, training may be improved over time. In this instance, each image received by the imaging unit may be further inspected by a human operative to decide whether the container shown therein is contaminated or not. The image may then be stored in the storing unit 104 as further information against which the machine-learning model may be trained at a future date. In this way, the machine-learning model may be improved over time by the input of further information about containers which may or may not be contaminated.

In this way, a fully automated approach is described with regards to determining whether a container 401 is contaminated or not. Consequently, the speed of processing of containers and the accuracy of the processing may be improved as compared to using human operatives.

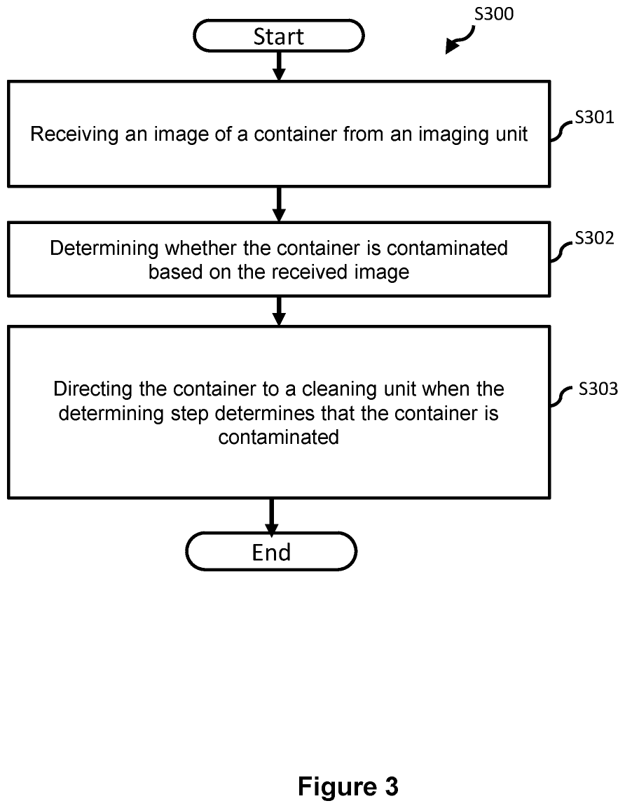

FIG. 3 shows a flowchart S300 of method performed by a control unit of the first embodiment. The method detects the presence of contamination in a container based on an image of the container captured by an imaging unit.

To this end, in a first step S301, the control unit receives from an imaging unit an image of a empty container so as to determine whether the container comprises contamination such as liquids of solids which prevent the container from being filled at a filing unit where new products may be placed in the empty container.

At step S302, it is determined whether the container is contaminated based on the received image. To achieve this, it is envisaged that a machine-learning model and/or a statistical model may be used to determine based on the image whether contamination is present in the container. To this end, the machine-learning model/statistical model may have been trained to recognise contamination based on multiple images of other containers which have been identified as contaminated or not. Therefore, the machine-learning model/statistical model may be trained based on previous instances of contamination so that when presented with a new image of a container, the machine-learning model/statistical model is able to identify where the container is contaminated. By using machine-learning model/statistical model, the training is more accurate than algorithmic methods relying on predefined rules such as whether a part of the image is a solid colour. Such rules fail when the contamination is the same colour as the container. On the other hand, using a model trained on actual images of example contamination results in a more robust output as to whether contamination is detected.

In step S303, based on the result of determining whether contamination is present, the control unit is arranged to direct the container to be cleaned when contamination is detected. The cleaning may be performed manually or automatically by a machine configured for such use. To this end, the control unit may control a conveying means, a push means, a diverting means or the like to redirect the path of the container to be cleaned. Similarly, if the control unit does not detect contamination then the container may be direct to a filling unit in which new products may be placed in the container. Similarly, direction to the filling unit may be performed by the control unit controlling the conveying means, diverting means pushing means of the like.

In this way, automatic redirection of the container depending on its contamination is achieved using the method according to the first embodiment.

### Second Embodiment

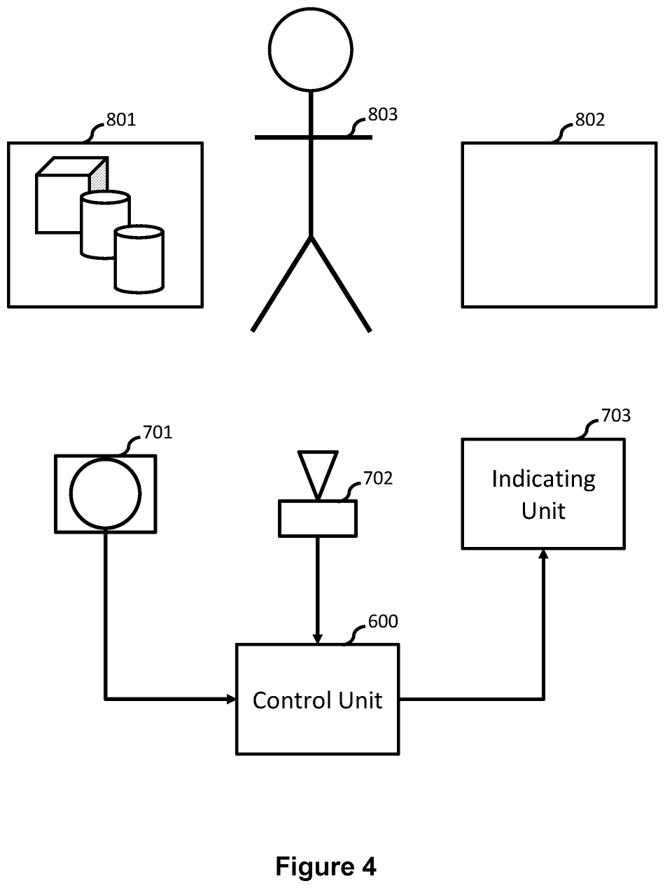

FIG. 4 depicts a control unit 600 according to the second embodiment of the present invention together with peripherals for use together with the control unit 600.

In particular, FIG. 4 relates to a location within a warehouse at which products are to be added to or removed from a container. In typical installations, a human operative 803 is positioned with a first container 801 and a second container 802. The first container 801 may be the container from which products are to be removed whilst the second container 802 may be arranged to receive products from the first container 801. The first container 801 may comprise different types of product or it may comprise all of the same type of product. The human operative 803 may be instructed to remove a predetermined number of products from the first container 801 and deposit them in the second container 802.

For example, in the example of a grocery ordering system. A customer's order may comprise one apple and two bananas. The first container 801 delivered to the human operative 803 may comprise a plurality of apples and a plurality of bananas. Therefore, the human operative 803 will be instructed to remove the one apple and two bananas from the first container 801 and deposit them in the second container 802. Accordingly, the customer's order is met in the second container 802 and therefore the second container 802 may be shipped for delivery to the customer whilst the first container 801 may return to a storage area in the warehouse.

Additionally or alternatively, each first container 801 may only store one type of product/item, for example only storing apples or only storing bananas. Therefore, to meet the customer's order it is expected that the container of apples is first brought to the human operative 803 who is instructed to remove one apple and place it in the second container 802. Next, the container of bananas is conveyed to the human operative 803 who is instructed to remove two bananas and place them in the second container 802. Therefore, the second container 802 contains the customer's order which may be shipped thereto whilst the container of apples and container of bananas may be returned to storage.

In each of the cases above, the human operative 803 will be tasked to positively confirm that the product removed from the first container 801 is the one expected. For example, the indicating unit 703 shown in FIG. 4 may instruct the human operative 803 to remove a first product (such as one apple) from the first container 801 and place it in the second container 802. Optionally, the indicating unit 703 may further indicate in which location within the second container 802 the first product should be located for example in an upper part of the second container 802. Advantageously, by locating in a particular part of the second container 802 the packing density within the second container 802 may be enhanced as an algorithmically calculated location for each of the plurality of products in the second container 802 will result in the optimal packing of products in the second container 802.

It is envisaged that the indicating unit 703 may take a different of different forms. For example, a display may be used for this function so as to display to the human operative 803 information necessary to perform the task of picking products from the first container 801 into the second container 802. Alternatively, a speaker may be used to speak out commands to the human operative 803.

The indicating unit 703 may further instruct the human operative 803 to capture a product identifier of the first product prior to placing it in the second container 802. To achieve this a product identifier (such as a barcode, an RFID tag or the like) affixed to the product may be captured by a product identifier reader 702 (such as a barcode reader, RFID reader of the like). Accordingly, once the product identifier has been recorded, the indicating unit 703 may decrement the number of products to be removed from the first container 801. Therefore, the usual process of operation for a human operative 803 is to be instructed by the indicating unit 703 the number of products to be removed from the first container 801. Accordingly, the human operative 803 removes a first product from the first container 801, reads its product identifier by the product identifier reader 702 and then places the product in the second container 802. The indicating unit 703 may decrement a counter indicating the remaining number of products to be removed from the first container 801. Accordingly, the human operative 803 repeats the same actions as before, reading the product identifier by the product identifier reader 702 for each product, until the indicating unit 703 indicates that no further products need to be removed from the first container 801. After which, removal of products from the first container 801 is completed.

By instructing the human operative 803 to use a product identifier reader 702 for each product then the risk is removed that the incorrect first container 801 (e.g. one containing oranges instead of apples) has been delivered to have products removed therefrom. For example, in a typical system, 1% of first containers may be incorrectly delivered comprising products not ordered by a particular customer. Therefore, the use of the product identifier reader 702 removes this risk by confirming that the first container 801 comprises the products expected to be placed in the customer's order.

Although the operative has been described as a human operative 803, it is envisaged that a robotic operative such as a robot system may be used to move a product from the first container 801 into the second container 802, for example, a robot arm.

However, by instructing the operative to use a product identifier reader 702 for each product a delay in time is added between removing the product from the first container 801 and deposition in the second container 802. Moreover, it may take additional time to orient the product correctly in front of the product identifier reader 702. For example, when the product uses a barcode then the barcode reader requires a line of sight to the barcode and obtain a clear image of the barcode. Therefore, the operative may be required to vary the orientation of the product until the barcode reader obtains a satisfactory read of the barcode, which may take a number of seconds.

The control unit 600 of the second embodiment is arranged to solve this problem. In particular, the control unit 600 is arranged to detect a product in the first container 801 based on an image of the first container 701 captured by an imaging unit 701. To this end, as shown in FIG. 4, an imaging unit 701 is positioned to be able to image a first container 801. Preferably, the imaging unit 701 is positioned to image the first container 801 prior to picking of products from the first container 801 by the human operative 803. Alternatively, the imaging unit 701 may be arranged to image products as they are picked as they are moved to the second container 802. Advantageously, by imaging a product as it is moved provides images of the product from different orientations as the human operative 803 naturally moves the product during the move. In this example, an image may be captured, for example, every 25 ms thereby generating a large number of images for each product move, which is advantageous for the recognition performed by the control unit 600.

When using a robot system in place of the human operative 803 it may be advantageous to instruct the robot system/arm to move along a predetermined trajectory when picking a product from a first container 801 to a second container 802. In particular, the robot arm may present the product to the imaging unit 701 in two or more poses with different parts of the product being displayed to the imaging unit 701. For example, a first side and a second side may be presented to the imaging unit 701. In this way, increased accuracy of product determination may be achieved because the product is presented in different orientations to the imaging unit 701.

In more detail, the control unit 600 is arranged to receive an image captured by the imaging unit 701 and, based on the captured image, arranged to determine a product located in the first container 801. Accordingly, when a product has been correctly identified the human operative 803 is no longer required to use the product identifier reader 702 to read the product identifier on each product. Instead, the human operative 803 may simply move the required number of items directly from the first container 801 to the second container 802 without performing a read of the product identifier. In this way, time and effort performed by the human operative 803 is saved resulting in an increase in the number of items picked by each human operative 803 per unit time. In particular, a saving of 100 ms per product can be saved. When many thousands of items are picked by human operatives 803 per hour then the time savings are substantial.

Moreover, the control unit 600 may be further arranged, when imaging a first container 801, to determine the number of products located therein.

Additionally or alternatively, the control unit 600 may be arranged to count the number of products moved from the first container 801 to the second container 802 by the human operative 803. For example, the control unit 600 may be further arranged to detect the number of products (and their type) moved by the human operative 803 from the first control 801 to the second container 802 and to compare it to an expected number of products to be moved. In this way, the control unit 600 can compare the number of products moved to an expected number of products to be moved (for example, the number of products in a customer's order) and to indicate to the human operative 803 that too many or too few products have been moved into the second container 802. In this way, too many or too few products are not delivered to a customer.

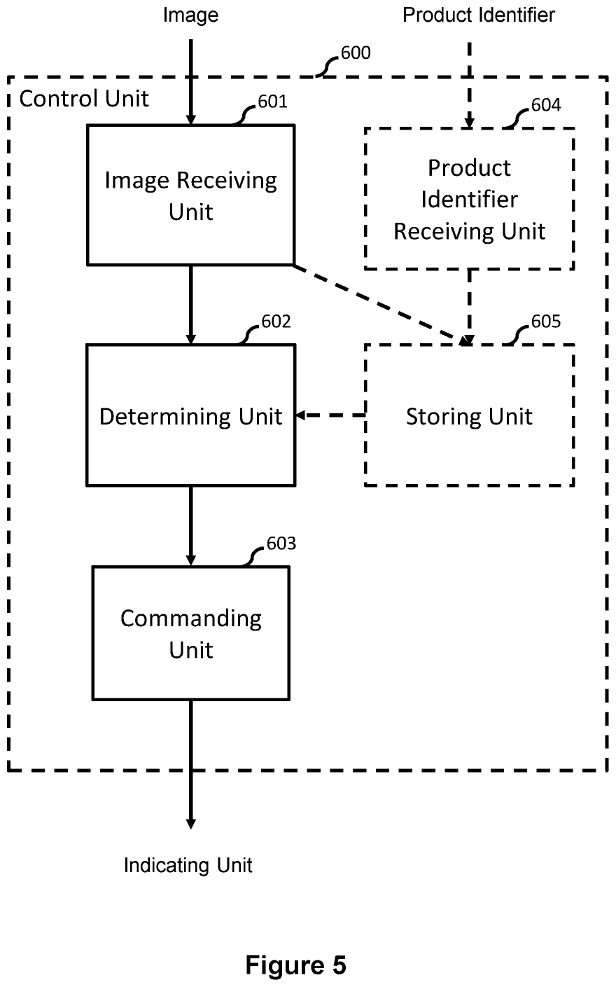

FIG. 5 shows further detail of the control unit 600 according to the second embodiment of the present invention. As shown, the control unit 600 comprises an image receiving unit 601, a determining unit 602 and a commanding unit 603. Optionally, the control unit 600 may further comprise a product identifier receiving unit 604 and a storing unit 605.

The image receiving unit 601 is arranged to receive an image captured of the first container 801 and the product contained therein. Optionally, the image receiving unit 601 may be arranged to process the image such as cropping the image, rotating the image, adjusting the colouring etc. so that images used by the determining unit 602 are consistent and as similar as possible.

The determining unit 602 is arranged to receive the captured image from the image receiving unit 601 and arranged to determine at least one product. In particular, the determining unit 602 may be arranged to use a statistical model and/or a machine-learning model to determine the identity of the product in the first container 801. As described previously, the determining unit 602 may use multiple images to make the determination as to the identity of the product.

Optionally, the determining unit 602 may determine a percentage confidence in the identity of the product in the first container 801. For example, a 70% confidence that the imaged product is the product identified. The determined percentage confidence may be threshold, for example, at 60%. Therefore, for products with a percentage confidence equal to or above 60% the control unit 600 may determine that the product has been correctly identified and therefore direct the human operative 803 to move a predetermined number of the product into the second container 802. On the other hand, for products with a percentage confidence below 60% the control unit 600 may raise an exception that the product has not been correctly identified, the handling of which will be discussed in connection with the commanding unit 603.

In particular, with regard to exceptions, the determining unit 602 may be arranged to determine exceptions such as when a product cannot be successfully identified. Additionally or alternatively when the captured image is blurry, unclear, not a product, unknown product etc. Thereafter, the determining unit 602 may be arranged to raise an exception, which is handled by the commanding unit 603.

More specifically, the commanding unit 603 is arranged to, when the determining unit fails to determine the identity of the product in the container, command an indicating unit to indicate that the determining unit 602 has failed to determine the identity of the product.

In particular, the commanding unit 603 may be arranged to command the indicating unit 703 that determination of the identity of the product in the first container 801 has failed. Consequently, the human operative 803 may be instructed to perform the action of passing the product in front of the product identifier reader 702 so as to determine a product identifier, as is the case in the traditional setup. In this way, the product identifier can be confirmed by the product identifier and not by the imaging unit 701.

On the other hand, when the determining unit 602 confidently identifies the product in the first container 801 then the commanding unit 603 may be arranged to command the human operative 803 to indicate this and therefore the human operative 803 need not use the product identifier reader 702 to read a product identifier. Instead, the human operative 803 can move the product directly into the second container 802. Moreover, the commanding unit 603 may be further arranged to command the indicating unit 703 to indicate a number indicative of a number of products to be removed from the container. In this way, the human operative 803 is directed to move a predetermined number of products into the second container 802, which, for example, may equal the number of products ordered by a customer.

In this way, in most situations, the product identifier reader 702 need not be used to read a product identifier and instead the control unit 600 provides the functionality to permit the determination of the contents of first container 801 based on an image received from the imaging unit 701. However, in those instances in which determination of the product is not possible, then the human operative 803 is indicated as to this situation and that the product identifier reader 702 should be used on the product to confirm its identity.

Optionally, the control unit 600 may further comprise a product identifier receiving unit 604 and/or a storing unit 605.

The product identifier receiving unit 604 may be arranged to receive an information indicative of the product identifier as received from the product identifier reader 702. For example, when the product identifier reader 702 is a barcode reader then the product identifier receiving unit 604 may be arranged to receive the barcode number and to optionally correlate the barcode number with a product. Alternatively, when the product identifier receiving unit 604 is an RFID reader then the product identifier receiving unit 604 may be arranged to receive a number stored in an RFID tag affixed to the product arranged to uniquely identify the product.

The storing unit 605 may be arranged to store information which may be used to train the machine-learning model/statistical model used by the determining unit 602. In particular, the storing unit 605 may be arranged to store images captured by the imaging unit 701 of the product (as received by the image receiving unit 601). Moreover, the stored images may be marked with information indicative of the product captured in the image. In one example, the marking of the images is performed by a human operative. In this way, the information stored in the storing unit 605 may be used to train the determining unit 602 to determine the product stored in the first container 801.

It is envisaged that the determining unit 602 may be trained once and offline, in other words, the machine-learning model need only be trained a single time using the information stored in the storing unit 605 after which the determining unit 602 may be able to suitable determine from an image received from the image receiving unit 601 the product shown therein. Moreover, such training need not occur whilst the control unit 600 is operating but rather prior to it being put into use so that when first used the determining unit 602 is suitably trained so as to determine the product in the first container 801.

Optionally, training may be improved over time. In this instance, each image received by the imaging unit 701 may be further inspected by a human operative to decide the product shown therein. The image may then be stored in the storing unit 605 as further information against which the machine-learning model may be trained at a future date. In this way, the machine-learning model may be improved over time by the input of further information about products stored in containers.

Preferably, the product identifier receiving unit 604 is used in conjunction with storing unit 605 so as to provide information for training the machine-learning model in the determining unit 602. It is envisaged that, as described previously, the determining unit 602 may be unable to determine a product based on the image received from the image receiving unit 601. After which, the commanding unit 603 may be arranged to command the indicating unit 703 that determination of the identity of the product in the first container 801 has failed. Consequently, the human operative 803 may be instructed to perform the action of passing the product in front of the product identifier reader 702 so as to determine a product identifier. Consequently, the product identifier receiving unit 604 will further receive the product identifier.

Therefore, the storing unit 605 will be arranged to receive both of the image of the product from the image receiving unit 601 and the product identifier from the product identifier receiving unit 604. The storing unit 605 may be arranged to store both of the image and the product identifier. In this way, the information required to train the machine-learning model is stored in the storing unit 605 without the need of a human operative to manually tag each image with information about the product displayed. In other words, by receiving both an image of the product and the product identifier and storing them in the storing unit 605 then the determining unit 602 can be trained on this information to recognise products automatically without a human operative manually tagging images. Therefore, over time the machine-learning model in the determining unit 602 will increase in accuracy as those products for which it is not well-trained to recognise are corrected using the above-described feedback loop of re-training with information about the product. In this way, the determining unit 602 may learn to better recognise those products which previously it could not recognise.

A particular challenge concerns product-packaging changes which may be changed by product manufacturers from time to time. To this end, the storing unit 605 may be arranged to store a packaging revision (determined from an external source) together with an image of the packaging to which it relates. In this way, care can be taken when training the determining unit 602 by only conducting training using images whose packaging revision matches the revision of the current packaging and not older/unused packaging revisions. To this end, when new packaging is used by a manufacturer it may be advantageous to capture images of the new packaging for use in training the determining unit 602. Additionally, there may be periods when multiple packaging revisions are being used, for example, new stock of products may have the newer packaging whilst older stock still has older packaging. Therefore, the storing unit 605 may store images of the same product but with different packaging. The determining unit 602 may then be trained to detect either of the packaging as the product. In this way, the control unit 600 is arranged to handle different packaging as used in real-world scenarios.

Optionally, once it is determined that a particular product has been sufficiently trained with a high level of confidence of identification then training for that product may be halted whilst focus is turned to other products for which the level of confidence of identification is not as high. Moreover, it is envisaged that automatically generated images of a product may be used to train the machine-learning model. For example, if a 3D model of the product is obtained prior to use of the control unit 600 then the determining unit 602 may be input with computationally generated images of the product digitally rendered from different angles and under differing lighting conditions. In this way, the speed of training the machine-learning model in the determining unit 602 can be increased because it does not rely on a customer ordering the product at which point the order will have to be performed by moving the product from the first container 801 into the second container 802.

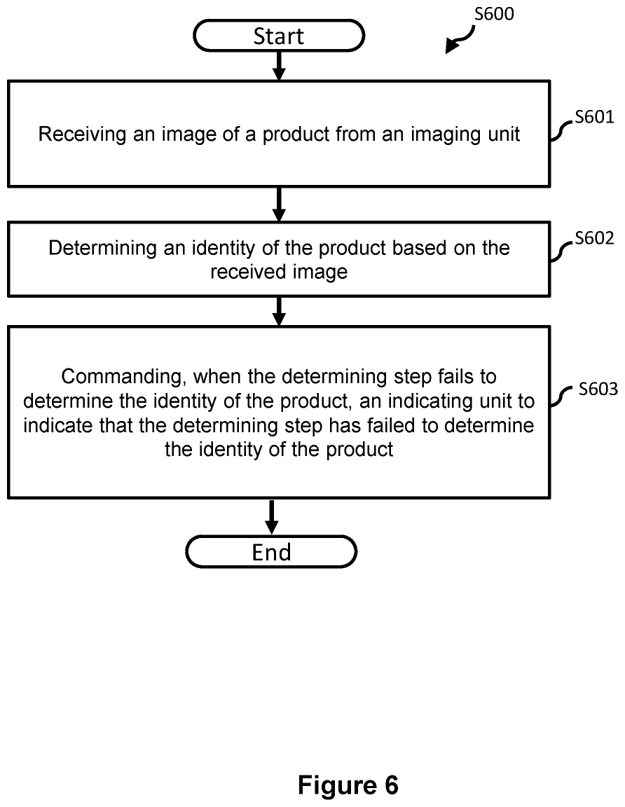

FIG. 6 shows a flowchart S600 of the method steps performed by the control unit 600 according to the second embodiment.

In a first step S601, the control unit 600 receives an image of a container from an imaging unit. The container comprises at least one product. Preferably, the products stored in the container are homogenous in that they are all the same type of product of the same size with the same packaging. In this way, the confidence in the output of the control unit 600 is increased.

In step S602, the control unit 600 determines the identity of the product in the container based on the received image. For example, the control unit 600 may use a machine-learning model and/or a statistical model to make the determination. In particular, step S602 receives the image of the product in the container and uses a trained machine-learning model to determine which product is shown. For example, the machine-learning model may be trained on other images of the container which have been tagged with information about the product they contain. In this way, the machine-learning model learns the products contained therein.

At step S603, the control unit 600 is arranged to command an indicating unit to indicate that the product determination has failed to determine the identity of the product, when step S602 fails to determine the product. In particular, the indicating unit may be a screen or other output means arranged to indicate to a human operative the state of product determination. When product determination is successful the human operative may simply transfer products from one container into another container. However, when product determination fails the human operative may be instructed to pass each product by a product identifier reading means (such as a barcode reader) to correctly identify the product.

In this way, the control unit 600 according to the second embodiment provides the functionality of avoiding the need for a human operative to use a product identifier reader when the product as imaged is correctly identified.

### Modifications and Variations

Many modifications and variations can be made to the embodiments described above, without departing from the scope of the present invention.

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered products, making single-product stacks an inefficient solution.

International patent application WO 98/049075A (Autostore), the contents of which are incorporated herein by reference, describes a system in which multi-product stacks of containers are arranged within a frame structure.

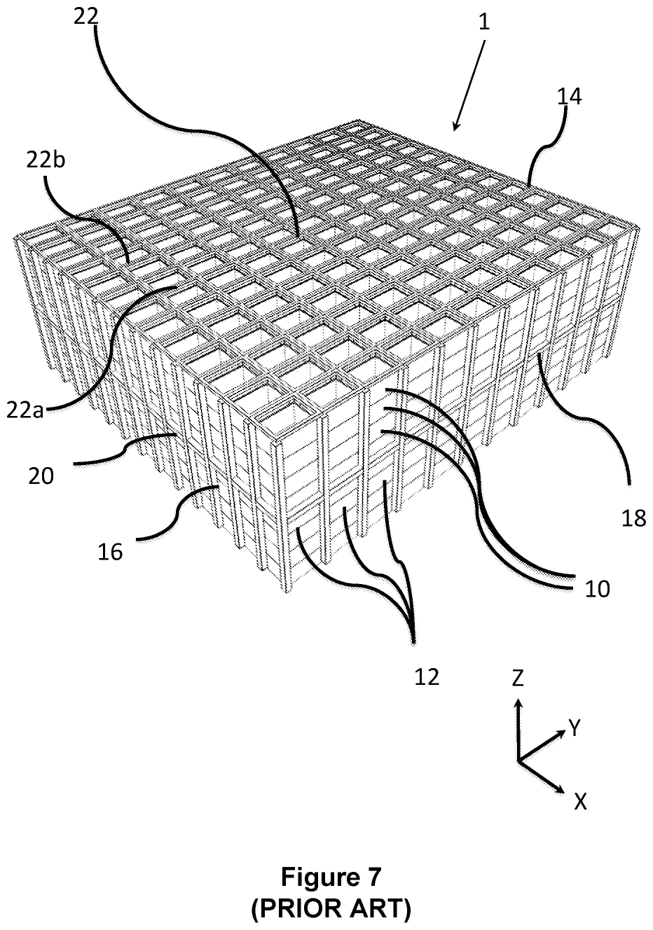

PCT Publication No. WO2015/185628A (Ocado) describes a further known storage and fulfilment system in which stacks of bins or containers are arranged within a framework structure. The bins or containers are accessed by load handling devices operative on tracks located on the top of the frame structure. The load handling devices lift bins or containers out from the stacks, multiple load handling devices co-operating to access bins or containers located in the lowest positions of the stack. A system of this type is illustrated schematically in FIGS. 7 to 10 of the accompanying drawings.

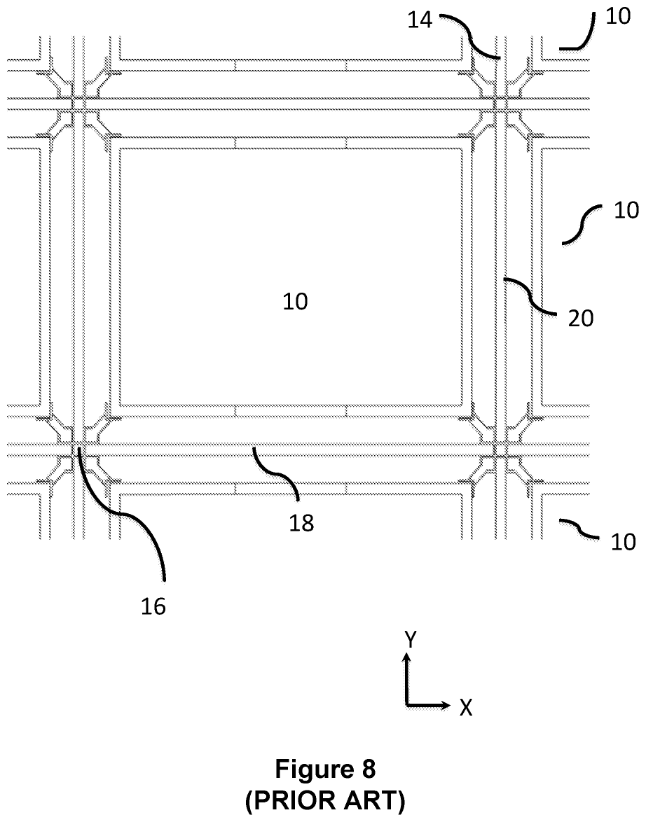

As shown in FIGS. 7 and 8, stackable containers, known as bins 10, are stacked on top of one another to form stacks 12. The stacks 12 are arranged in a grid framework structure 14 in a warehousing or manufacturing environment. FIG. 7 is a schematic perspective view of the framework structure 14, and FIG. 8 is a top-down view showing a stack 12 of bins 10 arranged within the framework structure 14. Each bin 10 typically holds a plurality of product items (not shown), and the product items within a bin 10 may be identical, or may be of different product types depending on the application.

The framework structure 14 comprises a plurality of upright members 16 that support horizontal members 18, 20. A first set of parallel horizontal members 18 is arranged perpendicularly to a second set of parallel horizontal members 20 to form a plurality of horizontal grid structures supported by the upright members 16. The members 16, 18, 20 are typically manufactured from metal. The bins 10 are stacked between the members 16, 18, 20 of the framework structure 14, so that the framework structure 14 guards against horizontal movement of the stacks 12 of bins 10, and guides vertical movement of the bins 10.

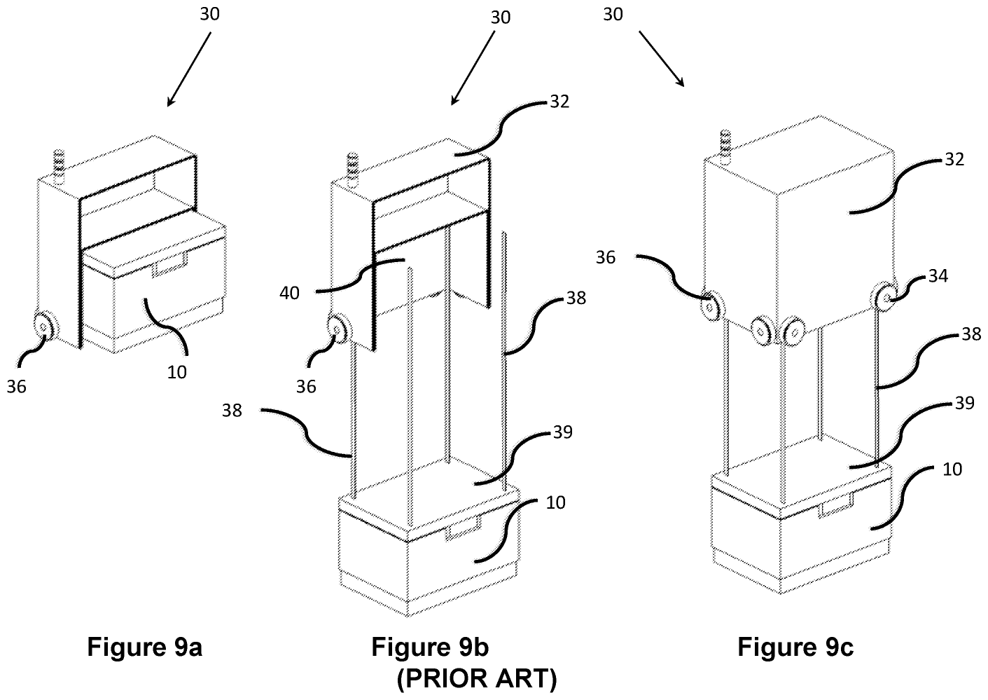

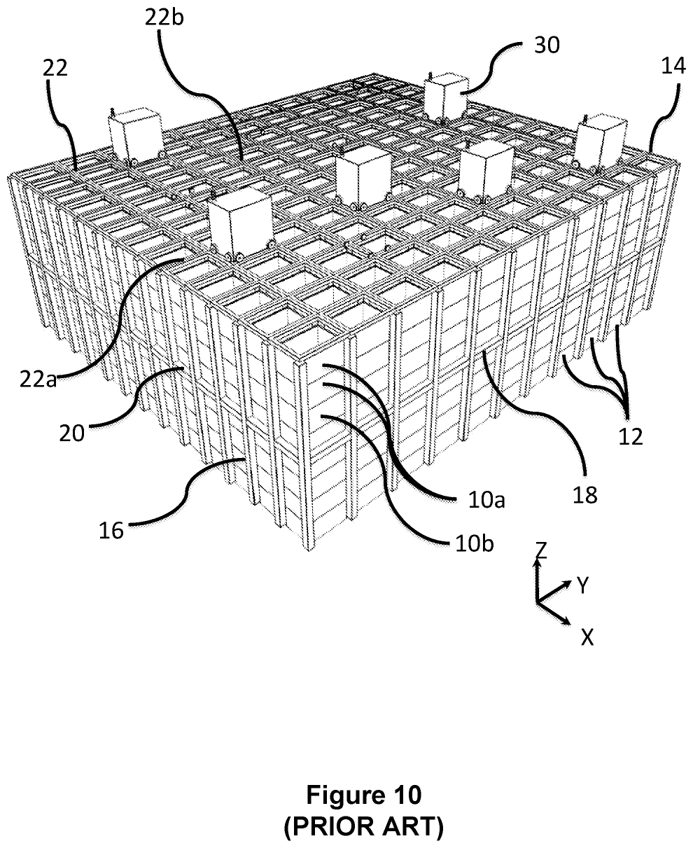

The top level of the frame structure 14 includes rails 22 arranged in a grid pattern across the top of the stacks 12. Referring additionally to FIGS. 9 and 10, the rails 22 support a plurality of robotic load handling devices 30. A first set 22a of parallel rails 22 guide movement of the load handling devices 30 in a first direction (X) across the top of the frame structure 14, and a second set 22b of parallel rails 22, arranged perpendicular to the first set 22a, guide movement of the load handling devices 30 in a second direction (Y), perpendicular to the first direction. In this way, the rails 22 allow movement of the load handling devices 30 laterally in two dimensions in the horizontal X-Y plane, so that a load handling device 30 can be moved into position above any of the stacks 12.

One form of load handling device 30 is further described in Norwegian patent number 317366, the contents of which are incorporated herein by reference. FIGS. 9(a) and 9(b) are schematic cross sectionals views of a load handling device 30 depositing a bin 10, and FIG. 9(c) is a schematic front perspective view of a load handling device 30 lifting a bin 10. However, there are other forms of load handling device that may be used in combination with the system herein described. For example a further form of robotic load handling device is described in PCT Patent Publication No. WO2015/019055, hereby incorporated by reference, (Ocado) where each robotic load handler only covers one grid space of the frame work structure, thus allowing higher density of load handlers and thus higher throughput for a given sized system.

Each load handling device 30 comprises a vehicle 32 which is arranged to travel in the X and Y directions on the rails 22 of the frame structure 14, above the stacks 12. A first set of wheels 34, consisting of a pair of wheels 34 on the front of the vehicle 32 and a pair of wheels 34 on the back of the vehicle 32, is arranged to engage with two adjacent rails of the first set 22a of rails 22. Similarly, a second set of wheels 36, consisting of a pair of wheels 36 on each side of the vehicle 32, is arranged to engage with two adjacent rails of the second set 22b of rails 22. Each set of wheels 34, 36 can be lifted and lowered, so that either the first set of wheels 34 or the second set of wheels 36 is engaged with the respective set of rails 22a, 22b at any one time.

When the first set of wheels 34 is engaged with the first set of rails 22a and the second set of wheels 36 is lifted clear from the rails 22, the wheels 34 can be driven, by way of a drive mechanism (not shown) housed in the vehicle 32, to move the load handling device 30 in the X direction. To move the load handling device 30 in the Y direction, the first set of wheels 34 is lifted clear of the rails 22, and the second set of wheels 36 is lowered into engagement with the second set of rails 22a. The drive mechanism can then be used to drive the second set of wheels 36 to achieve movement in the Y direction.

The load handling device 30 is equipped with a lifting device. The lifting device 40 comprises a gripper plate 39 is suspended from the body of the load handling device 32 by four cables 38. The cables 38 are connected to a winding mechanism (not shown) housed within the vehicle 32. The cables 38 can be spooled in or out from the load handling device 32, so that the position of the gripper plate 39 with respect to the vehicle 32 can be adjusted in the Z direction.

The gripper plate 39 is adapted to engage with the top of a bin 10. For example, the gripper plate 39 may include pins (not shown) that mate with corresponding holes (not shown) in the rim that forms the top surface of the bin 10, and sliding clips (not shown) that are engageable with the rim to grip the bin 10. The clips are driven to engage with the bin 10 by a suitable drive mechanism housed within the gripper plate 39, which is powered and controlled by signals carried through the cables 38 themselves or through a separate control cable (not shown).

To remove a bin 10 from the top of a stack 12, the load handling device 30 is moved as necessary in the X and Y directions so that the gripper plate 39 is positioned above the stack 12. The gripper plate 39 is then lowered vertically in the Z direction to engage with the bin 10 on the top of the stack 12, as shown in FIG. 9(c). The gripper plate 39 grips the bin 10, and is then pulled upwards on the cables 38, with the bin 10 attached. At the top of its vertical travel, the bin 10 is accommodated within the vehicle body 32 and is held above the level of the rails 22. In this way, the load handling device 30 can be moved to a different position in the X-Y plane, carrying the bin 10 along with it, to transport the bin 10 to another location. The cables 38 are long enough to allow the load handling device 30 to retrieve and place bins from any level of a stack 12, including the floor level. The weight of the vehicle 32 may be comprised in part of batteries that are used to power the drive mechanism for the wheels 34, 36.

As shown in FIG. 10, a plurality of identical load handling devices 30 are provided, so that each load handling device 30 can operate simultaneously to increase the throughput of the system. The system illustrated in FIG. 10 may include specific locations, known as ports, at which bins 10 can be transferred into or out of the system. An additional conveyor system (not shown) is associated with each port, so that bins 10 transported to a port by a load handling device 30 can be transferred to another location by the conveyor system, for example to a picking station (not shown). Similarly, bins 10 can be moved by the conveyor system to a port from an external location, for example to a bin-filling station (not shown), and transported to a stack 12 by the load handling devices 30 to replenish the stock in the system.

Each load handling device 30 can lift and move one bin 10 at a time. If it is necessary to retrieve a bin 10b (“target bin”) that is not located on the top of a stack 12, then the overlying bins 10a (“non-target bins”) must first be moved to allow access to the target bin 10b. This is achieved in an operation referred to hereafter as “digging”.

Referring to FIG. 10, during a digging operation, one of the load handling devices 30 sequentially lifts each non-target bin 10a from the stack 12 containing the target bin 10b and places it in a vacant position within another stack 12. The target bin 10b can then be accessed by the load handling device 30 and moved to a port for further transportation.

Each of the load handling devices 30 is under the control of a central computer. Each individual bin 10 in the system is tracked, so that the appropriate bins 10 can be retrieved, transported and replaced as necessary. For example, during a digging operation, the locations of each of the non-target bins 10a is logged, so that the non-target bins 10a can be tracked.

The system described with reference to FIGS. 7 to 10 has many advantages and is suitable for a wide range of storage and retrieval operations. In particular, it allows very dense storage of product, and it provides a very economical way of storing a huge range of different items in the bins 10, while allowing reasonably economical access to all of the bins 10 when required for picking.

However, there are some drawbacks with such a system, which all result from the above-described digging operation that must be performed when a target bin 10b is not at the top of a stack 12.

The above described storage and fulfilment system in which stacks of bins or containers are arranged within a framework structure may be used with either or both of the first and second embodiments of the present invention.

In particular, the first embodiment may be used with bins 10 leaving, entering or being transported from, to or between the framework structure. For example, before entering the framework structure the bin 10 may be examining using the control unit 100 of the first embodiment. If it is determined that the bin 10 is contaminated then it may be diverted to the cleaning unit 502 prior to entry into the framework structure and its use by the load handling devices 30. Alternatively, the load handling devices 30 may, as a matter of course, deposit a bin 10 from the framework structure in a location between the stacks, outside the stacks etc. for a determination by the control unit 100 as to whether the bin 10 is contaminated. If it is, then it may be cleaned before reinsertion into the stacks of bins. Similarly, on leaving the framework structure a bin 10 may be checked for contamination by the control unit 100 (and cleaned if necessary) before being allowed to continue along its journey.

Additionally or alternatively, the first embodiment may be used at a picking station adjacent to the framework structure and arranged to receive a bin 10 from the transporting device 30 for the removal of products from the bin 10 and/or the addition of products to the bin 10 by an operative (whether manual or automated picking). For example, before entering the picking station the bin 10 may be examining using the control unit 100 of the first embodiment. If it is determined that the bin 10 is contaminated then it may be diverted to the cleaning unit 502 prior to entry into the picking station. Similarly, on leaving the picking station a bin 10 may be checked for contamination by the control unit 100 (and cleaned if necessary) before being allowed to continue along its journey such as to enter the framework structure

Additionally or alternatively, the control unit 600 of the second embodiment may be used at a picking station adjacent to the framework structure and arranged to receive a bin 10 from the transporting device 30 for the removal of products from the bin 10 and/or the addition of products to the bin 10 by an operative 803. This operation may be assisted with the control unit 600 of the second embodiment which may be arranged to image the bin 10 to identify the products/items present therein. Accordingly, the operative 802 may be directed to remove a number of products from the bin 10 without the need to scan each product to determine its product identifier (such as barcode). In this way, operative time and effort is conserved because scanning of each product is not required. After the operations by the operative 802 are complete the bin 10 may be reinserted into the stacks or exit the stacks to another location.

### Integration of the Storage System and the Cleaning Unit

There was previously described a cleaning unit 502. The following will provide further information regarding the integration of such a cleaning unit 502 with the storage system shown in FIG. 7. The integration of the cleaning unit 502 with the storage system is not limited to either the first embodiment or the second embodiment. Instead, the cleaning unit 502 is arranged for integration with any storage system of the type depicted in FIG. 7, such as those manufactured and maintained by Ocado or by Autostore. To this end, the features of the first embodiment or the second embodiment are not necessarily required to achieve the integration of the cleaning unit 502 with the storage system of FIG. 7. The cleaning unit 502 described in this modification is one arranged to clean a bin 10. This may be achieved in many ways such as by way of solvents (such as water), manual agitation (such as bristles or jets of water) and the like. However, the following description may, optionally, be combined with the features of the first embodiment and/or the second embodiment without hesitation.

In the following description, the cleaning unit 502 with be described as a “tote-wash machine” but the functions are the same, namely the cleaning (or washing) of a bin 10. The terms bin 10 and tote are envisaged to be used interchangeably.

### Ingress Port & Egress Port

A “port” is a single vertical column in the storage system reserved for the ingress and egress of the totes to/from the framework structure. To this end, the framework structure which comprises a plurality of upright members 16 that support horizontal members 18, 20, is typically used to store stacked bins 10, as shown in FIG. 7. However, to form a port, a column of the framework structure is arranged to be clear/free of bins 10. In this way, the load handling device 30 is able to lift or lower bins 10 from the bottom of the framework structure to the top without obstruction. Therefore, if a conveyance means is provided at the bottom of the framework structure then the load handling device 30 is able to move bins 10 in and out of the framework structure by way of the port.

At or below the top level of the stored totes in the framework structure in the dedicated port column may be positioned a mechanical pad arranged to (a) receive a tote from a load handling device 30 in a framework structure egress port; (b) allow a load handling device 30 to pick-up a tote in a framework structure ingress port; and/or (c) perform both the preceding functions in a bi-directional port. The single direction ingress and egress ports can be designed to be reconfigurable into the opposite function with Programmable Logic Controller changes; but typically without requiring any mechanical changes.

### Bi-Directional Port

At some point at or below the top level of the stored totes in the framework structure in the dedicated port column may be positioned a mechanical pad designed to perform both functions of (a) receive a tote from a load handling device 30 in a framework structure egress port; and (b) allow a load handling device 30 to pick-up a tote in a framework structure ingress port. In this way, less space is required in the framework structure to perform the functions of ingress and egress from the framework structure allowing more columns of the framework structure to be assigned to the storage of bins 10.

Bi-Directional Port with Load Handling Device “Hover”

The bi-directional port described above may, optionally, have the additional functionality of allowing the load handling device 30 to deposit the tote on the mechanical receiving pad using the gripper plate 39. The load handling device 30 then raises its gripper plate 39 sufficiently for the port to move the deposited tote from the receiving pad on to a framework structure egress conveyor (or other conveyance means e.g. an Autonomous Guided Vehicle or the like). Then the port mechanism moves the next bin inbound to the framework structure on to the mechanical pad. The load handling device 30 will then lower the gripper plate 39 to pick up the framework structure ingress tote. The technique of holding the gripper plate 39 just high enough for a tote exchange under it, is known as “load handling device hovering”. This is more efficient in usage of each load handling device 30 particularly when the port mechanical receiving pad is situated low down in the framework structure. In this way, time is saved by each load handling device 30 which is not required to fully winch down and up its gripper plate 39 for a single bin. Instead, the winching down can deposit a first bin 10 whilst the winching up can retrieve a second bin 10. Accordingly, less time is required to exchange bins below the load handling device 30. The bi-direction port mechanism with load handling device hover is more efficient in terms of time required for a given throughput and the port itself is more efficient and will support a higher bin two way throughput rate.

### Tote-Wash Machine

The following described an example of the structure of a Tote-Wash Machine arranged to receive dirty totes and to process them until they have been cleaned. As explained previously, the Tote-Wash Machine is envisaged to perform the same functions as the cleaning unit 502.

The sections/phases of a tote-wash machine are:
Conveyor in-feed;
First stage: “de-trash” possibly by inversion of the tote, robotics arms with a variety of effectors, and suction devices. In this way, physical materials in the tote e.g. packaging, food, other waste, is removed;
Second stage: tote wash, by spray jets and possibly brushes. To remove any liquid or solid contaminants adhered to the surface of the tote;
Third stage: tote rinse. For example using plain water to remove any remaining chemicals;
The second and third stage may be undertaken with an inverted tote to aid draining;
Fourth stage: tote drying. This way be achieved using hot air or the like;
Totes leave the tote-wash machine by exit conveyor;
The stages may occur sequentially as tote moves through tote-wash machine; or may be performed in a single multi-purpose bay.

### Integrated Tote-Wash Machine

Integration of the tote-wash machine into the storage system may be achieved by connecting the in-feed and out-feed conveyors of the Tote-Wash Machine to egress and ingress ports, respectively, of the framework structure. Such ports have been described previously. Alternatively, the in-feed and out-feed conveyors of the Tote-Wash Machine may be connected to a bi-directional port of the framework structure. In this way, no manual handling of the totes is required to accomplish the round trip egress from the framework structure, tote wash and (return) ingress to the framework structure.

For simplicity of reference, an egress/ingress/bi-directional port connecting the Tote-Wash Machine to the framework structure may be referred to as a “Tote-Wash Port”.

### Totes Leaving the Framework Structure (Framework Structure Egress) at a “Tote-Wash Port”

A storage system controller may be associated with the storage system and arranged to control movement and operation of each of the load handling devices 30, as well as conveyors arranged to move bins 10 to/from the framework structure. Additionally, the mechanical pad may comprise sensors arranged to inform the storage system controller that there is a tote on the pad, this prevents the storage system controller tasking a load handling device 30 to place another tote on the pad when it is already occupied by a tote. The port may also have a sensor to detect that the gripper plate 39 has been retracted sufficiently to permit the movement of the tote clear of a receiving area; or this information may be communicated by the load handling device 30. Once the presence of a tote on the pad is confirmed and the load handling device 30 is clear of the totes; the storage system controller may command the pad mechanism to move (or release) the tote to a conveyor system. In the case of an integrated Tote-Wash Machine the conveyor may run to the tote-wash machine. The conveyors from several outfeed ports may be merged together prior to the tote-wash machine. Alternatively, the conveyor may form a stub; from which manually or automatic loading to an Autonomous Guided Vehicle or to a pallet for transportation by a pallet truck.

### Totes Inducted to the Framework Structure (Framework Structure Ingress) at a “Tote-Wash Port”

The mechanical pad of a port may further comprise sensors arranged to inform the storage system controller that there is a tote on the pad, this will trigger the storage system controller to task a load handling device 30 to pick-up the tote from the pad. The trigger may also be from a pre-announce scanner further down-stream on the conveyor, such as a light sensor which is activated when the tote passes thereby, before reaching the pad. The pad may also comprise a sensor to detect that the gripper plate 39 has been retracted sufficiently for the storage system controller to move another tote onto the pad.

In the case of an Integrated Tote Wash Machine, a conveyor may extend from the exit of the Tote Wash Machine to the ingress tote-wash port of the framework structure. Optionally, the conveyor on the exit of the tote-wash machine may form a stub, from which manual or automatic loading may occur to an AGV or to a pallet for transportation by a pallet truck. The totes may then be automatically or manually unloaded on to a conveyor stub from which totes are inducted to the framework structure (ingress) tote-wash port. The conveyor from the exit of an a tote-wash machine may be diverted into several conveyor spurs each feeding a separate framework structure (ingress) tote-wash port.

Operation with a Bi-Directional “Tote-Wash Port”

Tote-wash ports may be bi-directional, that is load handling devices 30 may drop-off dirty totes for washing and pick-up clean (freshly washed) totes from the same “tote-wash” port without the necessity to fully retract the gripper plate 39 into the load handling device 30. Typically, a conveyor leading to the infeed of an integrated tote-wash machine will be connected to one side of a bi-directional “tote-wash” port and a conveyor leading to the exit of an integrated tote-wash machine will be connected to a different side of a bi-directional tote-wash port.

In this way, as described previously with regard to bi-directional ports, the mechanical pad may receive a dirty tote from a load handling device 30. The mechanical pad may then dispatch the dirty tote to the tote-wash machine for cleaning. Simultaneously, a clean tote may leave the tote-wash machine and be held next to the bi-directional port until the dirty tote has been dispatched. After which, the clean tote may enter the mechanical pad ready for collection by a hovering load handing device 30.

Storage System Controller Interaction with the Tote Wash Functionality

The storage system controller or a sub-module thereof may record whether a tote is used for:
1) storing inventory i.e. totes storing items which may form a part of a customer order;
2) storing customer orders in sub-totes, i.e. a sub-tote for delivery to a customer containing products they have ordered;
3) has not been used for storing inventory or storing sub-totes since its last wash. Once a tote has been assigned to either 1) storing inventory or 2) storing sub-totes; it cannot be used for the other purpose until it has been washed.

For totes used for the storing inventory the storage system controller or a sub-module may implement at least one configurable rule specifying when the tote should be flagged for washing based on at least one of the following rules:
1) the elapsed duration since the last wash;
2) the number of call-outs since the last tote wash;
3) the number of times the tote has been picked to empty since the last wash;
4) the tote has been flagged as dirty by a picker, decanter, IMS (“Inventory Management Stations”) operative or supervisor has flagged the tote as dirty at a GUI;
5) the tote contents are specified on a configurable high risk product list. Typically, this would be inventory such as raw chicken, bleach, drain cleaner. For totes containing products specified in a high risk product list, the storage system controller or a sub-module, flags the tote for washing every N times it has been picked to empty; where N may take the integer value 1 or greater; and where a separate value of N may be stored and configured for each individual product; or a value of N may be stored and configured for particular groups of high risk products.

“Picked to empty” relates to the process of emptying a tote the products it contained by the process of picking products for transfer to a customer order at a pick station.

For totes used for storing sub-totes for delivery to a customer, the storage system controller or a sub-module may implement at least one configurable rule specifying when the tote should be flagged for washing including at least one of the following rules:
1) an elapsed duration since the last wash;
2) the number of call-outs since the last tote wash;
3) whether a picker, decanter, IMS operative or supervisor has flagged the tote as dirty at a Graphical User Interface (GUI).

With each rule specifying that a tote should be washed a separate configurable wash priority level may be assigned. The storage system controller can be configured such that totes marked at the highest priority levels cannot be used before they are washed. This would typically be totes flagged as dirty or totes that have stored high risk SKUs requiring washing each time the tote is picked to empty (i.e. emptied of the products it previously stored). The storage system controller maintains a backlog of totes immediately ready for washing based on the wash priority and the date and time the wash request was set. This allows the storage system controller to operate the tote wash function as an efficient background process; using surplus resources; but maintaining an adequate number of available totes in the framework structure to meet production requirements.

For a tote that has not been used for storing inventory or storing sub-totes since its last wash the storage system controller may delay the assignment to either 1) storing inventory or 2) storing sub-totes; until it needs to enlarge the population of one of these classes of totes.

Totes have all wash related data relating to wash history and contents history reset on the return to the framework structure from the tote-wash machine.

For facilities with separate framework structures for products stored at room-temperature and for products requiring a chilled environment, the integrated tote-wash may have ingress, egress and/or bi-directional ports in one or both grids. In the case where the tote-wash ports are only installed in one framework structure then totes may be transported between the framework structures using a transferring mechanism to access and return from the integrated tote-wash machine.

In the case where the tote-wash ports are only fitted to the framework structure storing room-temperature products, the storage system controller may hold newly washed totes in the framework structure for storing room-temperature products until the totes have cooled off from a hot wash in the tote-wash machine; before that newly washed tote becomes eligible for consideration to be moved into the framework structure for chilled products. This helps maintain local chill conditions in the framework structure for chilled products.

Non-integrated tote-wash machines do not feature such extensive integration with the framework structure. Therefore, to wash totes, the dirty totes are removed from Inventory Management Stations (previously referred to as pick stations), cleaned and then returned clean to the framework structure at Inventory Management Stations (previously referred to as pick stations). Typically, totes used for room temperature products are removed and returned at framework structure Inventory Management Stations for the room temperature framework structure. On the other hand, totes stored chilled products are removed and returned at framework structure Inventory Management Stations for the chilled framework structure. However, to accommodate problematic routes to the tote-wash machine for facilities with separate framework structures for room temperature and chilled products, all totes for washing may be removed and returned at Inventory Management Stations in one framework structure. The totes for the other temperature regime framework structure may be routed via transfers between the framework structures. Similarly, where there are a plurality of framework structures at a single temperature regime, totes may be removed and returned at a single framework structure's Inventory Management Stations the totes for washing for the other framework structure's being removed and returned via the framework structure transfers.

### Induction and Removal of Totes Via Ports

Totes, either empty or with contained inventory, may be inducted to, or removed from, the framework structure storage via at least one of:
Ingress Ports & Egress Ports
Bi-directional Ports
Bi-directional Ports With load handling device “Hover”

When ports are used in this manner they may further comprise scanning means to read an identifier, such as a barcode, QR code or RFID tag or other identity tag or label located on each tote that is to be inducted. Ports used for the induction of totes may further comprise devices to scan one or more labels of the inducted inventory; and may optionally have the option to enter the quantity of items of each product being inducted. In this way, the storage system controller can be made aware of the amount and type of products being stored in the storage system together with the container in which the product is stored. In this way, when required, fast and accurate retrieval of the product from the storage system can be effected. Alternatively, the scanning functionality may be built into mobile (wireless) devices used at the ports. In which case the ports may have barcodes, QR codes or other scannable labels to allow such mobile devices to identify the port at which the inventory is being inducted.

The foregoing description of embodiments of the invention has been presented for the purpose of illustration and description. It is not intended to be exhaustive or to limit the invention to the precise form disclosed. Modifications and variations can be made without departing from the spirit and scope of the present invention.

1. A control unit arranged to detect a presence of contamination in a container based on an image of the container captured by an imaging unit, the control unit comprising:
a receiving unit configured and arranged to receive an image of the container from an imaging unit;
a determining unit configured and arranged to determine whether the container is contaminated based on the received image; and
a commanding unit configured and arranged to, when the determining unit determines that the container is contaminated, direct the container to a cleaning unit.

2. The control unit according to claim 1, wherein the determining unit is configured to determine whether the container is uncontaminated based on the received image; and
the commanding unit is further configured to, when the determining unit determines that the container is uncontaminated, direct the container to a filling unit.

3. The control unit according to claim 1, wherein the determining unit is configured to determine whether the container is contaminated based on a statistical model.

4. The control unit according to claim 1, the control unit comprising:
a storing unit configured and arranged to store images, captured by an imaging unit, of containers which are contaminated and images, captured by an imaging unit, of containers which are uncontaminated,
wherein the determining unit is configured to be trained to determine whether the container is contaminated or uncontaminated based on image information stored in the storing unit.

5. The control unit according to claim 1, wherein the commanding unit is configured to command a diverting unit arranged to divert the container.

6. A control unit arranged to detect a product based on an image of the product captured by an imaging unit, the control unit comprising:
an image receiving unit configured and arranged to receive an image of a product from an imaging unit;
a determining unit configured and arranged to determine an identity of the product based on the received image; and
a commanding unit configured and arranged to, when the determining unit fails to determine the identity of the product, command an indicating unit to indicate that the determining unit has failed to determine the identity of the product.

7. The control unit according to claim 6, wherein the commanding unit is configured to, when the determining unit determines the identity of the product, command the indicating unit to indicate that the determining unit has determined the identity of the product.

8. The control unit according to claim 6, wherein the commanding unit is configured to, when the determining unit determines the identity of the product, command the indicating unit to indicate a number indicative of a number of products to be moved.

9. The control unit according to claim 6, wherein the determining unit is configured to determine an identity of the product based on a statistical model.

10. The control unit according to claim 6, the control unit comprising:
a product identifier receiving unit configured and arranged to receive a product identifier captured from the product; and
a storing unit configured and arranged to store the received image and the received product identifier,
wherein the determining unit is configured to be trained to determine the identity of the product based on image information stored in the storing unit.

11. The control unit according to claim 6, wherein the commanding unit is configured when the determining unit fails to determine the identity of the product, command the indicating unit to indicate that the product should have an product identifier captured.

12. A storage system comprising:
a first set of parallel rails or tracks extending in an X-direction, and a second set of parallel rails or tracks extending in a Y-direction transverse to the first set in a substantially horizontal plane to form a grid pattern having a plurality of grid spaces;
a plurality of stacks of containers located beneath the rails, and arranged such that each stack is located within a footprint of a single grid space;
a transporting device, the transporting device being configured to selectively move in the X and/or Y directions, above the stacks on the rails and configured to transport a container;
a cleaning unit; and
a control unit according claim 1, in combination with an image unit, wherein the control unit is configured and arranged to image a container received from the transporting device.

13. A storage system comprising:
a first set of parallel rails or tracks extending in an X-direction, and a second set of parallel rails or tracks extending in a Y-direction transverse to the first set in a substantially horizontal plane to form a grid pattern having a plurality of grid spaces;
a plurality of stacks of containers located beneath the rails, and arranged such that each stack is located within a footprint of a single grid space;
a transporting device, the transporting device being configured to selectively move in the X and/or Y directions, above the stacks on the rails and configured to transport a container;
a picking station configured and arranged to receive a product stored in a container transported by the transporting device; and
a control unit according to claim 6.

14. The storage system according to claim 12, wherein the transporting device has a footprint that occupies only a single grid space in the storage system, such that a transporting device occupying one grid space does not obstruct a transporting device occupying or traversing the adjacent grid spaces in the X and/or Y directions.

15. A method of detecting the presence of contamination in a container based on an image of the container captured by an imaging unit, the method comprising:
receiving an image of the container from the imaging unit;
determining whether the container is contaminated based on the received image; and
directing the container to a cleaning unit when the determining step determines that the container is contaminated.

16. A method of detecting a product based on an image of the product captured by an imaging unit, the method comprising:
receiving an image of the product from the imaging unit;
determining an identity of the product based on the received image; and
commanding, when the determining step fails to determine the identity of the product, an indicating unit to indicate that the determining step has failed to determine the identity of the product.

17. A storage system comprising:
a first set of parallel rails or tracks extending in an X-direction, and a second set of parallel rails or tracks extending in a Y-direction transverse to the first set in a substantially horizontal plane to form a grid pattern having a plurality of grid spaces;
a plurality of stacks of containers located beneath the rails, and arranged such that each stack is located within a footprint of a single grid space;
a transporting device, the transporting device being configured and arranged to selectively move in the X and/or Y directions, above the stacks on the rails and arranged to transport a container; and
a cleaning unit.

18. The storage system according to claim 17, comprising:
a picking station configured and arranged to receive a product stored in a container transported by the transporting device.

19. The storage system according to claim 17, wherein the transporting device has a footprint that occupies only a single grid space in the storage system, such that a transporting device occupying one grid space does not obstruct a transporting device occupying or traversing the adjacent grid spaces in the X and/or Y directions.

20. The storage system according to claim 17, comprising:
at least one of an ingress port, an egress port or a bi-directional port, wherein a port is formed by a column of the storage system arranged to be clear of containers and arranged to support the transporting device.

21. The storage system according to claim 20, wherein the port comprises:
sensors configured and arranged to detect a position of a container with respect to the port.

22. The storage system according to claim 17, comprising:
a bi-directional port configured and arranged to:
receive a container from the transporting device and allow the container to move to the cleaning unit; and
receive a container from the cleaning unit and allow the transporting device to pick-up a container.

23. The storage system according to claim 22, wherein the transporting device is configured and arranged to deposit the container at the bi-directional port, raise a gripper plate to permit the onwards movement of the container, wait for the bi-directional port to move a different container into position, lower the gripper plate to grip the different container and receive the different container.

24. The storage system according to claim 17, wherein the cleaning unit comprises:
a conveyor in-feed;
a de-trashing unit;
a washing unit;
a rinsing unit;
a drying unit; and
a conveyor out-feed.

25. The storage system according to claim 17, wherein the storage system comprises:
an in-feed conveyor configured and arranged to connect the cleaning unit to an egress port or a bi-direction port of the storage system; and
an out-feed conveyor configured and arranged to connect the cleaning unit to an ingress port or a bi-directional port of the storage system.

26. The storage system according to claim 17, comprising:
a controller configured and arranged to record whether a container is used for storing inventory or storing a customer order and disallow a container to switch from storing inventory to storing a customer order, or vice-versa, unless it has been cleaned by the cleaning unit.

27. The storage system according to claim 26, wherein the controller is configured and arranged to record for each container storing inventory:
an elapsed duration since the last wash;
a number of call-outs since the last container wash;
a number of times the container has been picked to empty since the last wash;
whether a container has been flagged as dirty; and/or
container contents which are specified on a configurable high risk product list.

28. The storage system according to claim 26, wherein the controller is configured and arranged to record for each container storing a customer order:
an elapsed duration since the last wash;
a number of call-outs since the last container wash; and/or
whether a container has been flagged as dirty.

29. The storage system according to claim 27, wherein the controller is configured to specify a priority level for each container based on the recorded information, where containers of a first priority level are unable to be used until they are washed,
the controller being configured to record a log of containers ready to be washed and prioritised based on the specified priority level and a date and time at which wash of the container was requested.

30. The storage system according to claim 27, wherein the controller is configured to reset the information about the container once it returns from the cleaning unit.

31. The storage system according to claim 17, wherein the storage system comprises:
a container station configured and arranged to introduce containers to the storage system or remove container from the storage system,
the container station including at least one of an ingress port, an egress port or a bi-directional port, and
the container station including a scanning unit configured and arranged to scan an identifier located on each container.

32. The storage system according to claim 31, wherein the container station comprises:
an input unit configured and arranged to receive an input of a quantity and type of items of product in the container when being introduced to the storage system.
